(19) United States
(12) Patent Application Publication
(10) Pub. No.: US 2013/0212847 A1
(43) Pub. Date: Aug. 22, 2013

(54) Container for a Cemetery Mausoleum for Inurnment of Cremated Remains and designed to occupy a cavity between a sealed Crypt and its Decorative Facing

(71) Applicant: Stephen John Gee, Chelsea (CA)

(72) Inventor: Stephen John Gee, Chelsea (CA)

(21) Appl. No.: 13/517,700

(22) Filed: Jun. 14, 2012

(30) Foreign Application Priority Data
Feb. 17, 2012 (CA) 2,769,135

(51) Int. Cl. A61G 17/08

(52) U.S. Cl. 27/1

(57) ABSTRACT

This inurnment container (urn) for cremated remains is designed for use in a Cemetery mausoleum and to occupy the cavity between a sealed Crypt and its decorative facing. The depth of this container and the design to fit this limited available space within the cavity will allow the use of previously unutilized space for the interment of the cremated remains immediately adjacent to an occupied Crypt without the necessity of disturbing the sealed Crypt.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OR THE PARTIES TO A JOINT RESEARCH AGREEMENT

Not Applicable.

### BACKGROUND OF THE INVENTION

1. Field of the Invention

A cemetery typically accommodates two types of burials; in-ground and above ground.

Above ground interment is in a mausoleum building specifically designed for the purpose. Within the mausoleum are Crypts and Columbarium niches.

A Crypt is a cavity generally approximating 3′0″ wide×3′0″ high×7′0″ deep constructed to hold a casket (coffin) and which is hermetically sealed when occupied. In front of the sealed Crypt is hung a facing, usually of marble or granite, approximately 40″ wide×40″ high×¾″ deep, on which is inscribed memorialization, epitaph and decorative features. The facing is hung using mechanical devises that permit an entire wall of similar sized facings to be adjusted and leveled to give a uniform appearance. Accordingly, between each individual sealed Crypt and its facing, and within the wall, is usually an adjustment space that varies between 1½″ and 2″ in depth created by the mechanical fastening/leveling devise.

A Columbarium is typically a plurality of niches, each a cavity approximately 1′0″ wide×1′0″ high×1′0″ deep, constructed to hold a container (urn) in which are contained cremated remains; it is not hermetically sealed and is usually faced on the open side with granite or marble, or occasionally glass to permit viewing of the urn. The Columbarium niches can be incorporated by design into the mausoleum walls or be freestanding units.

Cemeteries are facing requests from bereaved families to open sealed mausoleum Crypts, to add an urn holding a related family members cremated remains. Complying with the request can be difficult˜the design of this invention avoids the necessity of disturbing the sealed Crypt and offers a new interment option for cremated remains.

2. Description of Related Art

Typical prior art storage systems for holding cremated remains may be seen in the Hancovsky patent, U.S. Pat. No. 4,607,417; the See patent, U.S. Pat. No. 4,688,359; the Eickhof, U.S. Pat. No. 5,195,812; the Schorman patent, U.S. Pat. No. 5,287,603; the Hunter patent, U.S. Pat. No. 617,161; the Diem patent, U.S. Pat. No. 3,183,574; the Pangburn et al. patent, U.S. Pat. No. 3,754,805; the Thompson patent, U.S. Pat. No. 3,529,730; and the Pickel patent, U.S. Pat. No. 3,925,944.

The Neuberger et al. patent, U.S. Pat. No. 5,625,933, is a storage container (urn) designed with a fastening ‘system for storing a plurality of storage containers’ to the exterior of a wall to create a unitized Columbarium and ‘is a system for retaining and displaying a plurality of urns’.

The present invention is not for display or intended to be modular or to used with a plurality of similar units to form a Columbarium wall. It is designed to make use of a limited cavity that exists within the wall of a Crypt behind its existing decorative facing.

### BRIEF SUMMARY OF THE INVENTION

A storage container (urn) for cremated remains specifically shaped to occupy an existing construction cavity within the front wall of a Crypt. The invention is a closable box of approximately 1½″ depth designed to contain approximately 200 cubic inches of cremated remains and utilizes a hoof extension to hang on the back of a Crypt facing.

### BRIEF DESCRIPTION OF THE SEVERAL VIEWS OF THE DRAWINGS

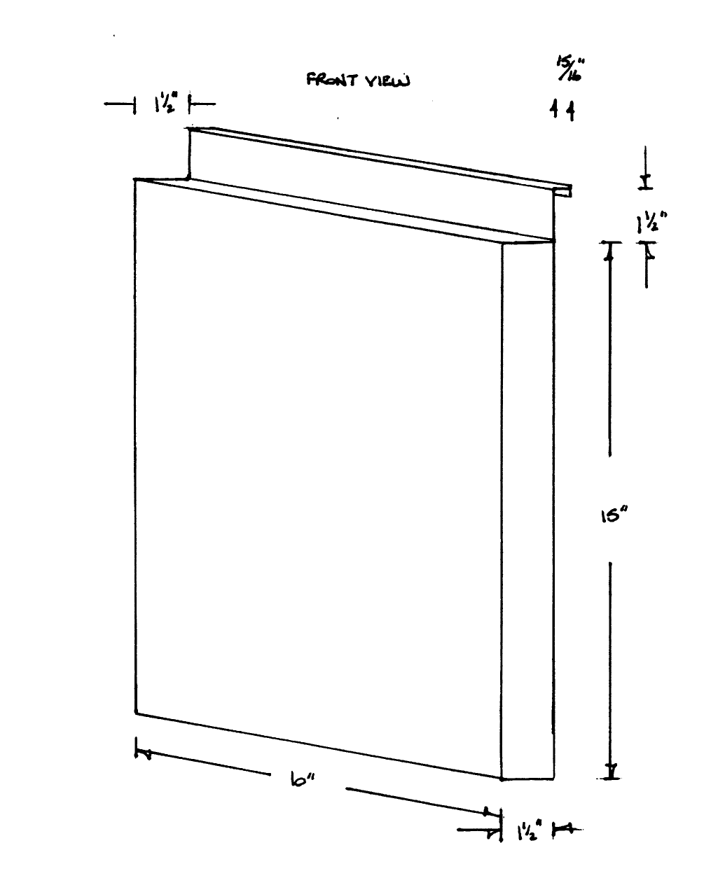

Page 9: FIG. 1˜Drawing 1 of 2˜Front view with dimensions (Front Page View).

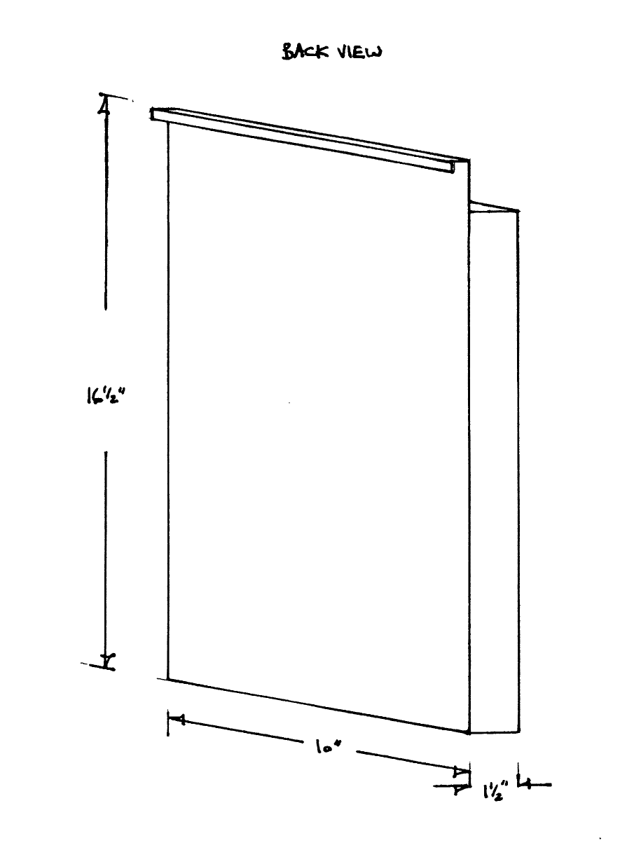

Page 10: FIG. 2˜Drawing 2 of 2˜Back view with dimensions.

### DETAILED DESCRIPTION OF THE INVENTION

This invention is a container (urn) for cremated remains designed to hang on the back of the facing of a mausoleum Crypt and to be embedded in the wall between the sealed Crypt and its facing.

Dimensions are:

Overall height: 16½″

Height of containment canister: 15″

Overall width: 10″

Depth: 1½″

Hanger depth: 15/16″

Drawings with dimensions are provided with this application.

This container for cremated remains is designed to have a capacity of approximately 200 cubic inches and is formed with sheet metal or similar material with a secure, closable opening to admit said cremated remains.

1. (canceled)

2. A storage container for Cremated remains comprising:
a plurality of walls with a sealable opening for receiving said Cremated Remains,
a flange extension with hook arrangement to enable container to hang on the inside of a mausoleum Crypt facing, between the Crypt facing and the sealed mausoleum Crypt.

3. A storage container in accordance with claim 2, which has a capacity of approximately 200 cubic inches and is approximately 1½″ in depth to enable it to be hidden behind the mausoleum Crypt facing and within the wall of the mausoleum.

4. A storage container in accordance with claim 2, which will fit within the narrow confines between the mausoleum Crypt facing and the sealed mausoleum Crypt created by the mechanical fastening and leveling devises typically used for attaching the Crypt facing.

5. The present invention should not be construed as limited to the form shown, which is intended to be illustrative rather than restrictive.
